(19) United States
(12) Patent Application Publication
(10) Pub. No.: US 2015/0062135 A1
(43) Pub. Date: Mar. 5, 2015

(54) DISPLAY APPARATUS AND DISPLAY METHOD

(71) Applicants: Kabushiki Kaisha Toshiba, Tokyo (JP); Toshiba Lifestyle Products & Services Corporation, Tokyo (JP)

(72) Inventors: Rikiya Kubo, Ome-shi (JP); Hirokazu Shimada, Fuchu-shi (JP); Yoshitaka Kobayashi, Kawasaki Kanagawa (JP); Yoshiyuki Matsuda, Chiba Chiba (JP)

(21) Appl. No.: 14/462,301

(22) Filed: Aug. 18, 2014

(30) Foreign Application Priority Data
Aug. 30, 2013 (JP) JP 2013-179521

(51) Int. Cl. G09G 3/00; G09G 3/36

(52) U.S. Cl. CPC G09G 3/001; G09G 3/3607; G09G 2320/10
USPC 345/520

(57) ABSTRACT

According to one embodiment, a display apparatus includes a receiver, a display controller, a camera, a processor, and a generator. The receiver receives data corresponding to a plurality of images. The display controller displays different images to a plurality of viewpoints, respectively. The processor assigns a number of viewpoints to each of the plurality of display images based on an image captured by the camera. The generator generates a signal for displaying the plurality of images according to the number of viewpoints assigned to each of the images.

### CROSS-REFERENCE TO RELATED APPLICATIONS

This application is based upon and claims the benefit of priority from Japanese Patent Application No. 2013-179521, filed Aug. 30, 2013, the entire contents of which are incorporated herein by reference.

### FIELD

Embodiments described herein relate generally to a display apparatus and a display method to present display images to a plurality of viewpoints.

### BACKGROUND

Display apparatuses (multi-view displays) capable of presenting various display images to a plurality of viewpoints, respectively, have been developed.

The use of multi-view displays as advertising media has been proposed. However, if the multi-view display is used as an advertising media, it is not easy to manipulate display images for direction of presentation because this may require, for example, presetting of input data or setting of a display in order to determine which viewpoints (directions) and what display images to output.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing a structure of a system in embodiments.

FIG. 2 is an exemplary diagram showing a table shared between an information distributor and a display setter.

FIG. 3 is an exemplary plan view of mat.

FIG. 4 is an exemplary block diagram showing a system configuration of the display apparatus.

FIG. 5 is an exemplary sectional view showing a structure of the display unit.

FIG. 6 is an exemplary diagram showing a structure of a lens unit.

FIG. 7 is an exemplary flowchart showing a procedure of a process of presenting display images.

FIG. 8 is an exemplary plan view of mat.

### DETAILED DESCRIPTION

Various embodiments will be described hereinafter with reference to the accompanying drawings.

In general, according to one embodiment, a display apparatus includes a receiver, a display controller, a camera, a processor, and a generator. The receiver receives data corresponding to a plurality of images. The display controller displays different images to a plurality of viewpoints, respectively. The processor assigns a number of viewpoints to each of the plurality of display images based on an image captured by the camera. The generator generates a signal for displaying the plurality of images according to the number of viewpoints assigned to each of the images.

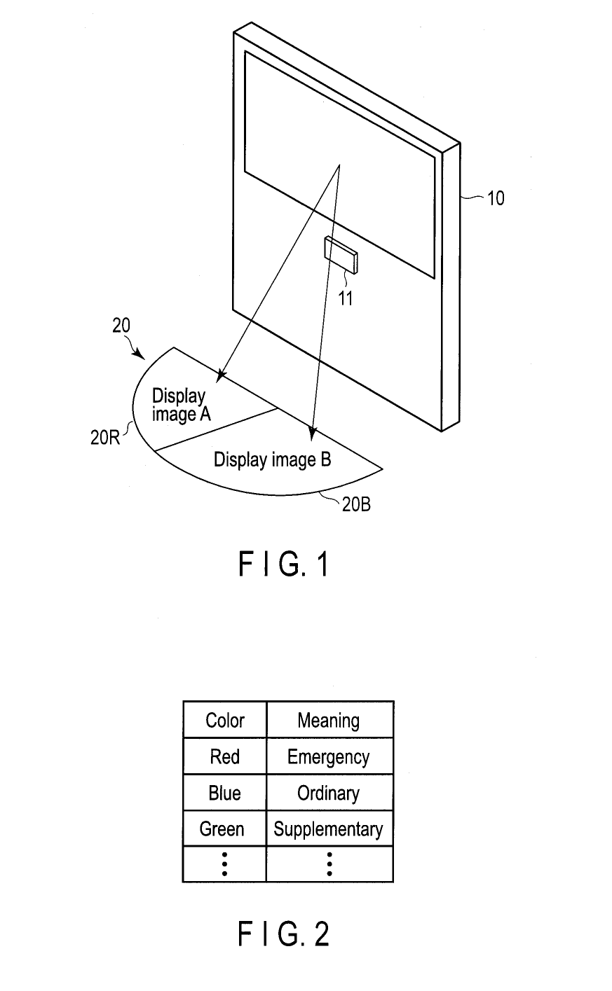

FIG. 1 illustrates a structure of a system.

The system comprises a display apparatus 10, a mat 20 and the like.

The mat 20 is placed on the ground in front of the display apparatus 10. The mat 20 comprises a plurality of sector patterns each having a different color. These sector patterns are placed at the same center and all have the same radius.

The display apparatus 10 is able to show different display images according to a position of a viewer. In other words, the display apparatus 10 is capable of presenting various display images to a plurality of viewpoints, respectively.

In the case of the mat 20 shown in FIG. 1, red 20R and blue 20B are arranged.

With regard to the information (display images) presented at each viewpoint of the display apparatus 10, a viewpoint on the left side of the display apparatus 10 created with the mat 20 placed in front becomes a display image A, whereas a viewpoint on the right side of the display becomes a display image B.

Here, in order to determine what information to display and from which viewpoints to display, an information distributor and a display setter share a table as shown in FIG. 2.

The distributor adds a code, red, to emergency information (display images), but a code, blue, to ordinary information for distribution. Here, when the display setter wishes users to see the display in such a way that the emergency information is viewed from the left and the ordinary information from the right, he or she prepares a mat with a color arrangement of red on the left and blue on the right, and places the mat in front of the display.

With the above preparations, the color codes added to the information and the color arrangement on the mat coincide with each other, and thus it becomes possible to determine what information to be output and which direction the information to be output toward.

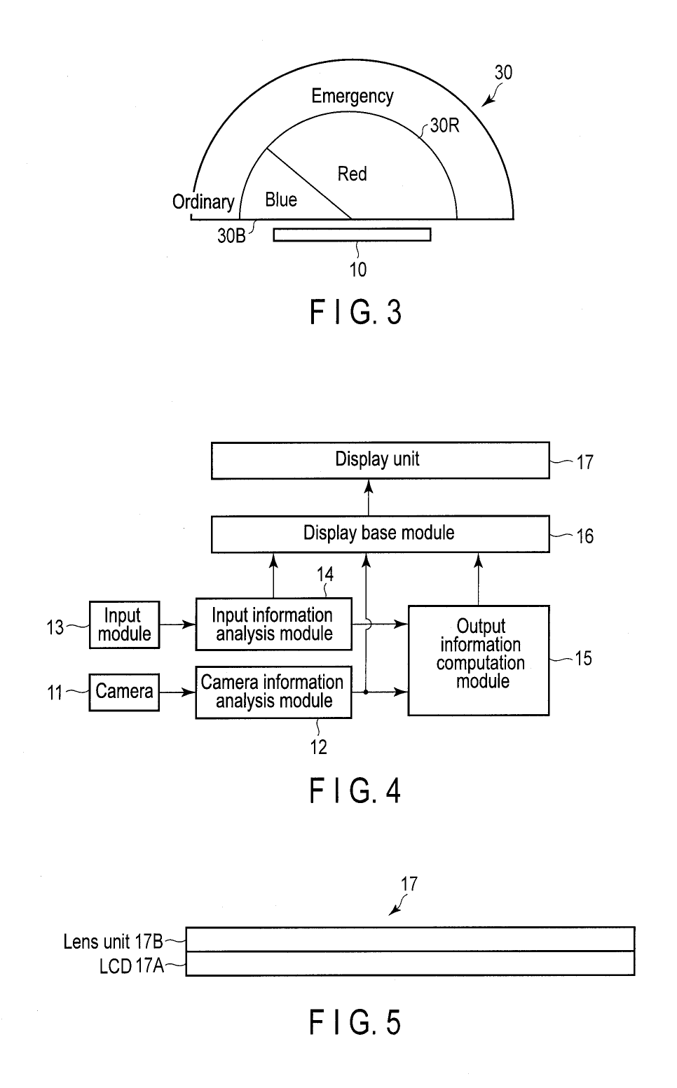

Also, by using a mat 30 shown in FIG. 3, not only the direction of the information but also the number of viewpoints can be differentiated. The mat 30 comprises a red region 30R in which red is arranged and a blue region 30B in which blue is arranged. The ratio of the red region 30R to the blue region 30B is 7:2. The display apparatus 10 outputs display images in such a format that emergency information is output by a ratio of seven viewpoints from the front to the right and ordinary information is output by a ratio of two viewpoints to the left.

The display determines the number of viewpoints assigned to the information to be output based on the ratio in the recognized color arrangement on the mat. In this embodiment, the mat having a large ratio in red and a small ratio in blue is employed so that the emergency information can be reported to a large number of people. Therefore, with regard to the information displayed on the multi-view display, there are more viewpoints for the emergency information.

Next, a system configuration of the display apparatus will be explained. FIG. 4 is a block diagram of the system configuration of the display apparatus.

The display apparatus 10 comprises a camera 11, a camera information analysis module 12, an input module 13, an input information analysis module 14, an output information computation module 15, an display base module 16 and an display unit 17 and the like.

The camera information analysis module 12 is configured to analyze an image input from the camera 11 and calculate the color arrangement on the mat and the ratio of each color. The image captured by the camera 11 contains information which indicates the number of viewpoints to be assigned to each of a plurality of display images. The information comprises a plurality of colors.

To the input module 13, display image data corresponding to the plurality of display images are input. Each display image data has a color code added thereto indicating a color. The input module 13 may comprises a plurality of input terminals corresponding to the plurality of display images. In addition, the input module 13 may be configured to receive the display image data via one input terminal on which a plurality of display images are superimposed.

The information analysis module 14 is configured to analyze and obtain the color codes added to the display image data input to the input module 13, and to organize the display image data according to what color each display image data corresponds to.

The output information computation module 15 is configured to compute which direction each display image should be output to and how many viewpoints should be used when outputting, based on the information of the color arrangement and its color ratio on the mat analyzed by the camera information analysis module 12 and the information of the color of the display image data analyzed by the input information analysis module 14.

The display base module 16 is configured to generate, based on the outcome of the computation by the output information computation module 15, a display image signal to present the display image corresponding to each viewpoint and to output the generated display image signal to the display unit 17. The display base module 16 also controls the display apparatus 10 in its entirety.

FIG. 5 is a sectional view of an example of a structure of the display unit 17. As shown in FIG. 5, the display unit 17 comprises a liquid crystal display (LCD) 17A and a lens unit 17B arranged on the LCD 17A. The lens unit 17B is bonded on the LCD 17A to fit therewith. The lens unit 17B comprises a plurality of lens mechanisms to output, in respective directions, a plurality of light beams corresponding to a plurality of pixels in the display images to be displayed on the LCD 17A. The lens unit 17B may comprise, for example, a liquid crystal gradient index (GRIN) lens. This liquid crystal GRIN lens can form a refractive-index distribution with an electrode using a flat liquid crystal layer.

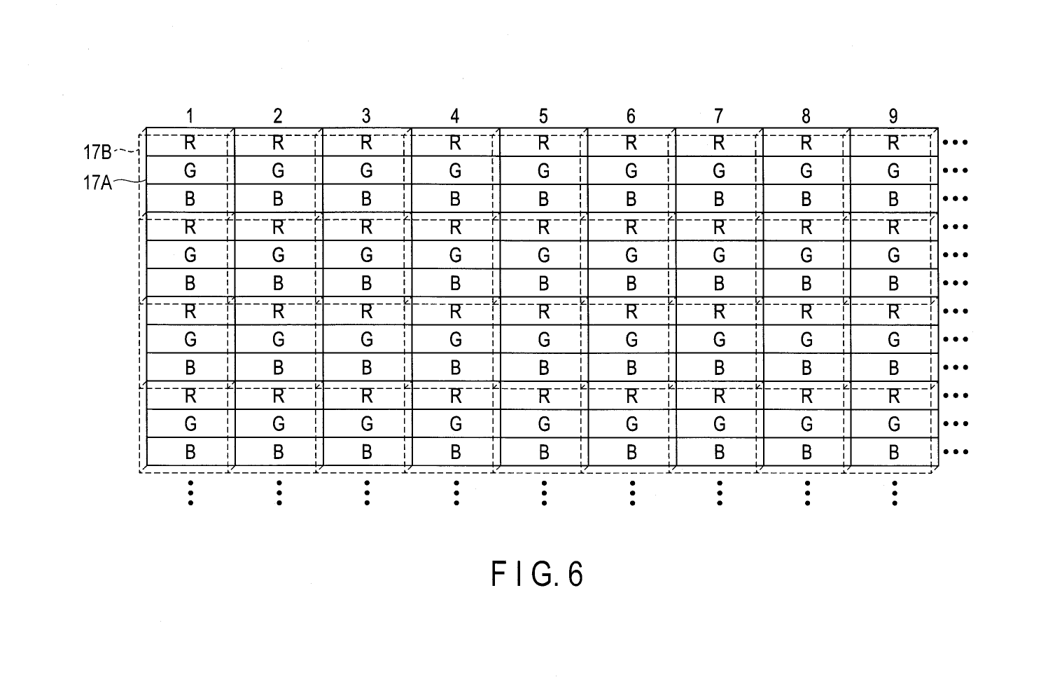

FIG. 6 illustrates a structure of the lens unit. As shown in FIG. 6, a plurality of red (R) sub-pixels of the LCD 17A are arranged in columns. Similarly, a plurality of green (G) sub-pixels of the LCD 17A are arranged in columns. In a similar way, a plurality of blue (B) sub-pixels of the LCD 17A are arranged in columns. A set of pixels consisting of red, green and blue form one unit and a plurality of such units are arranged in rows and columns. For each pixel, a pixel of the liquid crystal GRIN lens 178 is provided.

The liquid crystal GRIN lens 17B controls the direction of the light output from the red sub-pixel, green sub-pixel and blue sub-pixel arranged in rows.

The multi-view display comprises a plurality of units, each consisting of, for example, nine adjacent columns of pixels. With this structure, it is possible to control the direction of the light output from each column in one unit individually. Where, for example, nine adjacent columns of pixels constitute one unit, the multi-view display can show up to nine display images.

The display apparatus 10 is configured to control, based on the image captured by the camera, the direction of the light output from each column in each unit. The display apparatus 10 is configured to recognize the color arrangement on the mat in the image and the ratio of each color. The display apparatus 10 is configured to control, based on the recognized ratio of each color, the direction of the light radiating from each column in each unit.

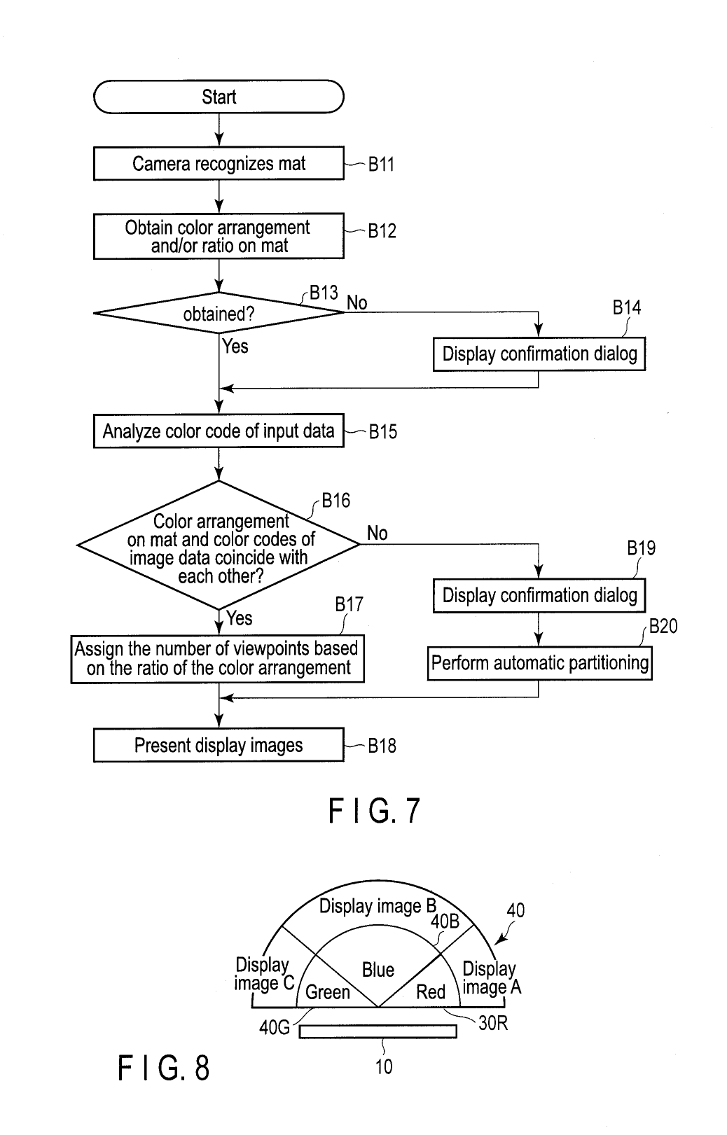

FIG. 7 is a flowchart of an example of a procedure for a process of presenting the display images. With reference to the flowchart of FIG. 7, the procedure of the process of present the display images will be explained.

First, the camera information analysis module 12 recognizes the mat from the image captured by the camera 11 (block B11). At the time of recognizing the mat, the camera information analysis module 12 obtains the color arrangement and the color ratio on the mat (block B12). If the camera information analysis module 12 fails to recognize the mat and the colors (No in block B13), the display base module 16 provides notification by displaying a confirmation dialog or the like on the LCD 17A to the effect that recognition of the mat failed (block B14).

If the camera information analysis module 12 succeeds in recognizing the mat and the colors (Yes in block B13), the input information analysis module 14 analyzes the display image data input into the input module 13. The input information analysis module 14 detects the color codes added to the input display image data (block B15).

If the color arrangement on the mat and the color codes of the information all coincide with each other (Yes in block B16), the display base module 16 assigns the number of viewpoints based on the ratio of the color arrangement on the mat (block B17).

If the color arrangement on the mat and the color codes of the information do not completely coincide with each other (No in block B16), the display base module 16 provides notification by displaying a confirmation dialog on the LCD 17A to the effect that the information cannot be presented normally (block B19). The display base module automatically calculates for the number of viewpoints to be assigned (block B20). Regarding the rules of this automatic calculation, it may be an option that more serious emergency information may be assigned with more viewpoints. The display base module 16 generates the display image signal to present the display image to the direction of each viewpoint (block B18).

Let us suppose here the case where, for example, a mat 40 having a color ratio as shown in FIG. 8 is placed for the display apparatus which can present display images to nine viewpoints in an implementation of the present proposal mentioned above.

The mat 40 comprises a red region 40R in which red is arranged, a blue region 40B in which blue is arranged and a green region 40G in which green is arranged. The ratio of the red region 40B to the blue region 40B and to the green region 40G is 2:5:2. The display apparatus 10 is configured to output information in a format that information A is output by a ratio of two viewpoints from the right, information B is output by a ratio of five viewpoints from the front and information C is output by a ration of two viewpoints from the left.

Note that, in FIG. 1, the mat has a fan shape, but it may also be rectangular as long as it is a shape which helps easy recognition of the color arrangement and the ratio.

Also, a fence, a placard, a rope or the like may be placed in front of the display to partition the viewer area. In this case, the respective colors may be arranged on an inner side with respect to an area-partitioning fence or placard so as to distinguish areas, controlling the ratio of the information. Further, it may be possible that a number or the like is added to the fence and placard to specify the direction and range of the area by the number without arranging colors.

As described above, in order to partition an audience area, it becomes possible to easily move partitions of the audience area by using not the mat but fences, placards, or the like. Therefore, depending on the degree of the viewers' demand for information, the ratio in the audience area is now easily changeable. Also, even if there are already individuals in front of the display waiting to see the information before supplying from the display, the audience area can easily partitioned and necessary information can be reported to each of the individuals who wish to see the information.

Although colors are used in the embodiments, any means may be employed as long as it is possible to recognize the regions. For example, one possible means is that the same signs of different sizes are placed in front of the camera and recognized by the camera, and the signs are compared to each other in size to determine the number of viewpoints (more viewpoints for a larger sign).

For the data input into the input module 13, not only a display image stream but also text data can be used. It is also an option that a tag of a color code is embedded in the sentences of a text and the text is segmented on the display side so as to display to the direction of each corresponding viewpoint.

According to the present embodiments, it becomes easy to set what display image to present from each viewpoint by assigning the numbers of viewpoints to display images based on an image captured by the camera.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display apparatus comprising:
a receiver configured to receive data corresponding to a plurality of images;
a display controller configured to display different images to a plurality of viewpoints, respectively;
a camera;
a processor configured to assign a number of viewpoints to each of the plurality of display images based on an image captured by the camera; and
a generator configured to generate a signal for displaying the plurality of images according to the number of viewpoints assigned to each of the images.

2. The apparatus of claim 1, wherein the image comprises information which indicates the number of viewpoints assigned to each of the plurality of display images.

3. The apparatus of claim 2, wherein the information comprises a plurality of colors.

4. The apparatus of claim 3, wherein the processor is configured to assign the numbers of viewpoints to each of the plurality of display images based on a ratio of each color.

5. The apparatus of claim 1, wherein the display controller comprises a liquid crystal display (LCD) and a lens unit thereon.

6. The display apparatus of claim 5, wherein the lens unit comprises a liquid crystal gradient index (GRIN) lens.

7. A display method of a display apparatus comprising a display controller which receives data corresponding to a plurality of display images receive and is configured to display different images to a plurality of viewpoints, respectively, the method comprising:
assigning a number of viewpoints to each of the plurality of display images based on an image captured by a camera; and
generating a signal for displaying the plurality of images according to the number of viewpoints assigned to each of the display images.
